(19) United States
(12) Patent Application Publication
(10) Pub. No.: US 2007/0208588 A1
(43) Pub. Date: Sep. 6, 2007

(54) SYSTEM FOR DEVELOPING A VALUES-BASED, BEHAVIOR-DRIVEN HUMAN RESOURCES SYSTEM

(75) Inventors: Margaret Ann Rhoades, Albuquerque, NM (US); Delise S. Crimmins, San Antonio, TX (US); Linde Louise Harned, Paradise Valley, AZ (US); Terry Leon Millard, Colorado Spring, CO (US); Sherry K. Roberts, Albuquerque, NM (US); Jeffrey Robert Sullivan, Oak Hill, VA (US); Mary Gayle Watson, Plano, TX (US); Shelley Sue Wells, Phoenix, AZ (US)

Correspondence Address: PEACOCK MYERS, P.C., 201 THIRD STREET, N.W., SUITE 1340, ALBUQUERQUE, NM, 87102, US

(73) Assignee: Performance Solutions, Inc., San Antonio, TX (US)

(21) Appl. No.: 11/627,854

(22) Filed: Jan. 26, 2007

Related U.S. Application Data
(60) Provisional application No. 60/763,131, filed on Jan. 26, 2006.

(51) Int. Cl. G06Q 10/00; G06Q 30/00

(52) U.S. Cl. 705/1

(57) ABSTRACT

The present invention includes a software system for developing a values-based, behavior-driven human resources system for at least one organization that includes a plurality of personnel. The software system includes a first software program that is operable to receive at least one input and generate at least one values-based, behavior-driven business factor based on the at least one input and a first sub-program operable to receive the at least one values-based, behavior-driven business factor and generate at least one output based on said at least one business factor and communicate the at least one output to the personnel.

### CROSS-REFERENCE TO RELATED APPLICATIONS

This application claims priority to and the benefit of the filing of U.S. Provisional Patent Application Ser. No. 60/763,131, entitled “Program For Creating And Sustaining A High Performing Organizational Culture”, filed on Jan. 26, 2006, and the specification thereof is incorporated herein by reference.

### BACKGROUND OF THE INVENTION

The present invention relates to software programs and methods for creating and sustaining a high performance organizational culture.

For many organizations, such as businesses, and the like, a constant struggle exists when attempting to define business values and incorporate the values into business practices. Often, values of an organization are not properly reflected in its human resources program.

It is desirable to provide a software program and method that enables users to define organizational values and incorporate these defined values into sub-programs.

### BRIEF SUMMARY OF THE INVENTION

The present invention includes a software system for developing a values-based, behavior-driven human resources system for at least one organization that includes a plurality of personnel. The software system includes a first software program that is operable to receive at least one input and generate at least one values-based, behavior-driven business factor based on the at least one input and a first sub-program operable to receive the at least one values-based, behavior-driven business factor and generate at least one output based on said at least one business factor and communicate the at least one output to the personnel.

The present invention is a comprehensive program designed to develop and sustain a high performing, values-based, organizational culture. The present invention is useful in high performing companies in any customer service industry including but not limited to: airline, hotel and hospitality, retail and consumer products, financial services, and healthcare. The invention creates high performing cultures from the internal and external customer perspective.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a block diagram showing the system of the present invention; and

FIG. 2 is a flowchart showing the steps of a method in accordance with the present invention.

### DETAILED DESCRIPTION OF THE INVENTION

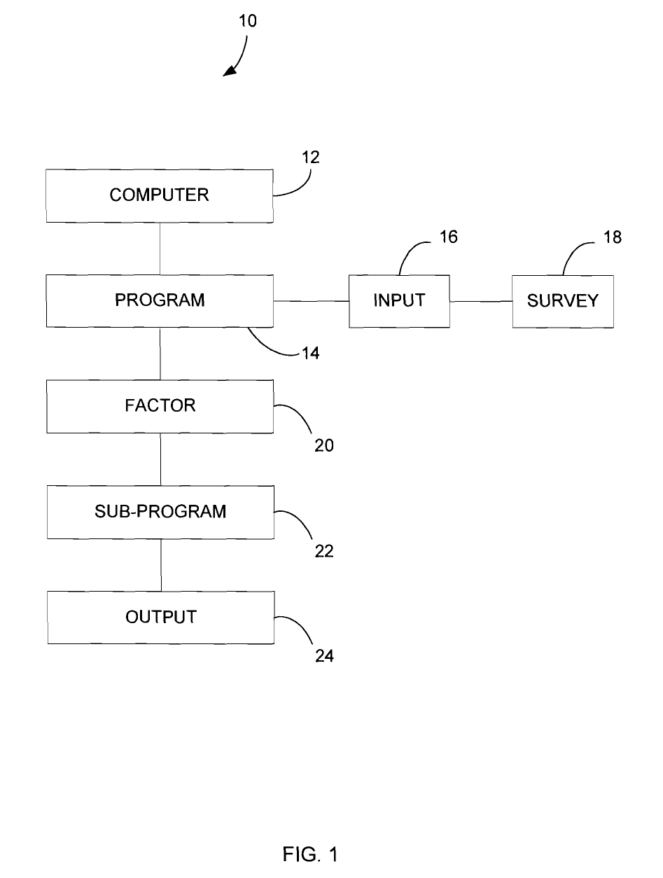

Referring now to FIG. 1, a system for developing a values-based, behavior-driven human resources system for at least one organization that includes a plurality of personnel in accordance with the present invention is indicated generally at 10. System 10 includes computer 12 in communication with program 14. Program 14 is operable to receive input 16. Input 16 may be generated by, but is not limited to, survey 18. Survey 18 may be utilized to enter input 16 directly to program 14. Program 14, upon receiving input 16, generates factor 20 that is based on input 16. Factor 20 is preferably a value-based behavior driven factor, discussed in more detail below. Sub-program 22 receives factor 20 and generates output 24. Output 24 is preferably communicated to the personnel of the organization by any suitable communication, discussed in more detail below.

The organization may be, but is not limited to, an airline, a hotel and hospitality businesses or organization, retail and consumer products businesses or organizations, financial services businesses or organizations, and healthcare businesses or organizations. Those skilled in the art will appreciate that the organization may be a for-profit or a not-for-profit organization, while remaining within the scope of the present invention.

The personnel may be, but is not limited to, independent contractors, employees, owners, customers, and clients of the organization.

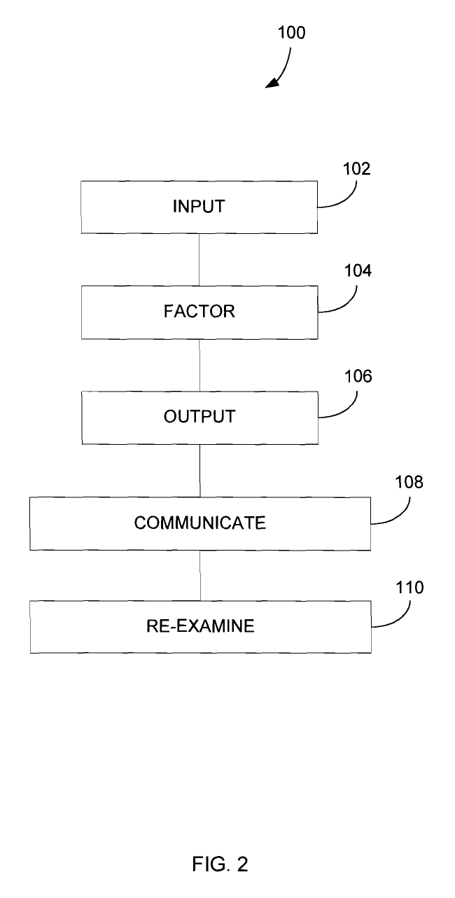

Referring now to FIG. 2, a method for operating a system, such as the system 10 shown in FIG. 1, in accordance with the present invention is indicated generally at 100. Method 100 includes input step 102 where an input, such as input 16 shown in FIG. 1, is received by a program, such as program 14 shown in FIG. 1 and running on a computer, such as computer 12 shown in FIG. 1. In step 104, program generates factor, such as factor 20 in FIG. 1, and the factor is based on input received in step 102 and is preferably a value-based behavior driven factor, discussed in more detail below. In a step 106, a sub-program, such as sub-program 22 in FIG. 1, receives the factor from the step 104 and generates an output, such as output 24 shown in FIG. 1. In a step 108, the output is communicated to personnel of the organization and in a step 110, the input, the factor, and the output are re-examined and updated, if necessary, discussed in more detail below. Step 108 may be performed on an annual basis, a predetermined interval, or any other interval as deemed necessary by the users of system 10 and method 100.

In a non-limiting example, a program 14 for system 10 is a a business results program (“Business Results program”). The Business Results program is designed to more fully engage all organizational personnel in finding smarter ways to conduct the business of any company. The Business Results program acknowledges that for-profit and not-for-profit organizations both need to manage their financial performance to allow maintenance and growth of ever more effective quality any company. Often, little changes that might escape the attention of managers will be evident to front line personnel and those changes can make a significant difference.

The Business Results program approach is based on the following principles.

1. Communication: The Business Results program increases the bi-directional flow of performance information and ideas and provides more timely information on performance to all personnel. Personnel also need more information about the organization performance relative to the marketplace and competitors including information about quality, safety, efficacy, and financial performance. Systems need to enhance the flow of information from front line personnel to senior leadership about new ideas and concerns.

2. Business Literacy: A basic understanding of simplified business and performance numbers can help personnel better understand what makes their organization healthy. Basic understanding of costs and margins are essential to helping personnel identify and influence changes that will make a positive contribution. When personnel understand the business of the company, they will be more likely to make meaningful contributions beyond expectations. Personnel must have meaningful opportunities to suggest and participate in positive change. Advanced literacy requires understanding simple financials and expanded performance metrics.

3. Performance Metrics: Establish meaningful performance metrics and share the results. The performance metrics reflect performance all personnel can impact and something that is critical to achieving the next level of performance. Performance numbers have to be timely and tied to behaviors.

4. Personal Involvement/Ownership: Provide a personal stake in the outcome for all personnel. When rewards are clearly tied to departmental and organizational performance, personnel are much more likely to think and act like owners. Short term “games” that target desired performance and encourage fun can make an important contribution a sense of involvement and ownership. The rewards for meeting the goals established for each game can contribute to the sense of pride, camaraderie, and return on invested effort. Financial rewards generated from equity programs like stock ownership and from well constructed profit sharing or bonus programs can also be an important source of a sense of personal ownership. In order to maximize the impact of equity personnel must have the opportunity to influence how business is conducted. If the reward increases as the margin of success increases, the motivation level goes up proportionately and the entire personnel team benefits.

5. High-Spirit Culture: At the heart of the Business Results program culture are people who care about each other and their customers—people who not only take pride in the quality of their work, but also feel the obligation to continually improve how their work is done. Building such a culture has to be purposeful and must be clearly centered of behaviors that reflect the values of the organization. It must be a culture built on love and not fear. High-spirit cultures bring many benefits, not the least of which are better retention, more fun, better service, happier personnel, better business outcomes, and more satisfied customers. The culture is crucial.

The Business Results program engages all personnel in providing quality products and services with increased profit margins. The Business Results program is built on the premise that literate and motivated people at every level of an organization can dramatically improve organizational performance and help create a remarkable experience for customers and the organization's personnel. Leveraging the advantage of literate and motivated people in an organization requires leadership and the implementation of supporting systems.

Preferably, a committee of personnel oversees the administration of the Business Results program within the organization. The committee is preferably representative of various functions and levels throughout the organization. Alternatively, the personnel on the committee includes customers and clients. The committee assists in the application and implementation of the Business Results program throughout all levels of the organization. Preferably, senior management of the organization sponsors and supports the effort of the Business Results program.

The Business Results program preferably obtains input 16 by assessing the culture of the organization, such as by survey 18 or the like. Assessment methods include, but are not limited to, existing survey data, augmenting existing survey efforts; surveys such as through a local area network or the web by electronic means for ease of collection and analysis. Surveys should include simple questions with a few open ended opportunities to share thoughts. Input 16 in the Business Results program, therefore, is a culture input.

In addition, survey 18 can include one-on-one interviews and small focus discussion groups, which can greatly amplify understanding of information received through surveys. The intent of interviews and focus groups should be to mine a broad cross section of personnel groups and develop a snapshot view of attitudes and personnel engagement issues.

Preferably one-on-one interviews and focus groups include questions such as, but not limited to:
Do your ideas get serious consideration by supervision?
Do you have a clear understanding of the business performance of your department and organization?
Do you routinely see measures of the quality of service provided by your department and the organization?
Do you know how your organization's performance rates against other organizations?
Are you treated like an adult professional at work?
What is the most important single thing that could be done to make your department more successful in providing outstanding service or improving financial performance?
Do you feel safe in questioning a doctor or supervisor's guidance or procedures?
What is the most significant thing that could be done to improve the patient experience in your arena?
Does someone encourage you every week?
Would you recommend your organization and department for treating your immediate family if cost were not a consideration?

Survey 18 should be conducted with all personnel involved in the Business Results program, and results of survey are preferably published. Assessment or survey 18 results should then be used to focus follow-on efforts and metrics development, discussed in more detail below. Assessment or survey 18 results are then utilized as input 16, such as by data entry into program 14, electronic transfer of surveys received through the local area network or the web, or similar data entry, as will be appreciated by those skilled in the art.

Program 14 then generates at least one values-based, behavior-driven factor 20 based on input 16. Preferably, factor 20 is a metric factor. Metrics are a finite measure or measures that provide the opportunity to compare performance in one period of time against performance in another period of time. Metrics are generally thought of in terms of statistics and numbers. Often they are used in spreadsheet programs to compare and contrast performance, but just as often they can be represented in charts, graphs and pictures. Metrics can be as simple as number of dollars collected this week, and as complex as multiple number ratios.

Preferably metric factor 20 is directly related to the personnel's job, is simple enough to understand with no more than three seconds thought, is limited to no more than three topics, and are numbers that individual or departmental work can influence. Preferably, metric factor 20 can be made to move and be influenced by the efforts of one division or department.

Metric factor 20 is utilized by sub-program 22 to generate an output 24, such as a chart, graph, or picture that clearly reflects motion from week to week. Preferably, output 24 is a dashboard measurement, discussed in more detail below. Sub-program 22 is utilized to determine which metric factor 20 generated by program 14 is to be utilized in output 24. Metric factor or factors 20 are preferably selected with all personnel involved in the analysis and selection process. When selecting metric factors 20 on which personnel will be evaluated or will evaluate themselves it is essential that the personnel be represented in the selection process. As a general rule, personnel are more likely to buy-in to goals and objectives they participated in establishing.

When metric factor 20 is selected, a written description must be developed that explains why that particular metric was selected, how it will improve quality of service and products, efficiency, business performance, and general satisfaction. The description will also explain how individual and work group performance can move the metric. Finally, the description should provide a desired level of performance—what is the goal the metric should be moved to achieve?

Sample metrics, which obviously depend on the type of organization, include, but are not limited to (this example is for a medical setting):
Readmits for same issue/month
Labor hours/procedure/week
Customer ratings at excellent or greater as a ratio of total customers seen
Call Button Response Times
Percentage of infections for a specific procedure
Patient or family complaints per patient population
Department Cost Per Patient Seen
Overtime Per Month
Total Customers Seen
Cost of medication per month divided total customers on unit
Departmental cost per patient compared to previous months
Organizational margins relative last year and yearly goal
Patient Census Relative to Goals
Revenue per imagery machine relative to goal and previous years
Patient waiting time from schedule to actual procedure

When personnel at every level of the organization understand how their organization is performing and are provided the opportunity of impact how it is performing they become more engaged in the endeavor. When leaders understand the key metrics that drive and reflect organization performance they are able to make decisions that drive improvement. The principle is at work in the Business Results program approach to sharing metrics with front line personnel. When personnel understand the meaning in key metrics they have a greater interest in influencing them. When given the chance to influence the improvement of organizational policies and processes personnel are likely to contribute many enhancements that will impact the bottom line and more deeply engage them in the process of improving service and products while simultaneously becoming more attached to the organization for which they work.

Dashboard measurement 24 is preferably a maximum of three metrics 20 that measure the daily performance of a department and/or the organization. The dashboard measurement will preferably be updated weekly or more often. Personnel will be trying to make those metrics move to meet goals they have determined are achievable; goals that contribute directly to important performance issues in their department.

The following chart shows a sample of a dashboard for corporate, team and individual metrics.

Example of a Performance Dashboard

[image]

Alternatively, output 24 is a reward-centered Business Results program game based on factor 20. Reward centered Business Results program games are short term contests that allow work groups to compete against a goal they establish for a reward they chose. Games are created locally to move some performance metric, such as metric factor 20 in a positive direction. Rewards are preferably funded by the increased revenue generated in the improved performance.

The objective of game 24 is preferably related to some performance the work group feels is important to achieve such as, but not limited to, productivity, revenue, safety, quality, or customer service. The criteria for success and moving toward that success must be measurable or quantifiable.

Preferably, games 24 are limited to no more than 90 days, the goals for success must be achievable in the time permitted, are limited to a natural work group, do not encourage competition with another work group, are fun and very visible and rewards for success should preferably include a celebration. In addition, rewards for success in game 24 is preferably non-monetary, scoreboards make monitoring progress simple and fun, only one game 24 is played at a time, and the goals are preferably not amendable—teams must make the original goal to win.

The Business Results program game rewards should never be a money amount because money has no trophy value and is not really memorable. However, each person who participated in the game should share in a reward and celebration resulting from achieving the game goal.

The major reward of game 24 should be the celebration of achievement when participants win. Examples of rewards for the Business Results program games include, but are not limited to
Movie passes
Gift Certificates for Dinner
Gift Certificates for any Products
Boss or supervisor service for the work group. This includes things like washing cars, shining shoes, cooking a meal, or doing someone else's job for a day
Early release from work for a day
Distribution of unique pins or desk decorations
A credit or “get out of jail free” coupon for later specific transgressions
Pizza or ice cream lunch or break on a specified day
Lottery Tickets
Tickets to Sporting Events

Preferably, the Business Results program is communicated throughout the organization including communication from leaders of the organization to front line personnel and vice versa, such as in step 108 shown in FIG. 2.

Leaders preferably communicate to the front line with leadership walk rounds, routine periodic updates, daily updates, weekly updates, e-mail and telephone messages, quarterly messages or similar type or any type of communication suitable for the organization, as will be appreciated by those skilled in the art.

Front line personnel preferably communicate to leaders of the organization by monthly breakfast or lunch discussions in each organizational division where the leaders preferably listen and take notes. Front line personnel also preferably communicate to leaders of the organization through a business proposal system implementation that utilizes a simple cost benefit analysis where personnel explain why they believe there is a significant return on investment with implementation of their idea. This approach helps front line personnel learn to think in terms of return on investment and the cost of doing the business of providing high quality products and services. The business proposal system of the Business Results program preferably provides responsiveness, transparency, and results. Responsiveness means that the proposal must result in an acknowledgement that it has been received within seven days. With computer managed systems this requirement can be met upon submission. The submitter must learn at that time when a response to the content can be expected. When the idea review cycle is completed every submitter must receive an explanation of what was decided and why.

Transparency can be maintained by making all submissions and the attendant responses available to all who wish to investigate what has been suggested and what has resulted. This is relatively easy to do if the system is computer based. Finally, the results of each idea must be shared with the submitter in a timely fashion. There must be a clear statement of the result of the review. Will the idea be implemented or not? Why? Those questions must be answered in the response. One of the ways to build trust and open lines of communication that is created by this system is to have senior staff call the suggestor and thank them for their idea—whether or not it is adopted. That personal touch helps make it clear that leaders genuinely appreciate and encourage input from the front lines.

Alternatively, output 24 is a financial link to performance or a direct reward for performance, such as profit sharing, stock options, ESPP purchase plans, and other variable pay alternatives discussed in more detail below.

Three critical components are preferably in place to maximize the success of the organization through personnel involvement efforts. First, personnel must have a basic understanding of the business—how the business is successful and makes money. Second, personnel have to be currently engaged in the business and have clear and timely information on results, such as how personnel are performing against metrics. Third, personnel preferably have a stake in the game—some way to enjoy and share in the success. These can be non-financial rewards and experiences like the Business Results program games, or they can be more formal incentive and variable pay plans, or a combination of both.

There are a variety of types of variable pay plans, all with the common purpose of engaging and motivating personnel to do their best, utilize their skills and knowledge, and to contribute to business results. Keep in mind that some organizations successfully use more than one type of plan or a hybrid approach. The most important element in selecting the right plan is to clearly understand the culture and the unique issues surrounding how to do business. Not all organizations have the right culture and the right leadership to engage all personnel in financial incentives. Those organizations may be much better served to fully utilize non-financial rewards to gain desired levels of personnel involvement.

Following are typical examples of variable pay plans utilized; discussed in more detail below:
Profit Sharing
Individual Incentives
Group/team Incentives
Gainsharing
Sales Incentives
Equity plans/ESOP

Preferably, personnel are provided with comprehensive business training, which will enable personnel to understand and contribute to dashboard measurements 24, games 24, and financial links 24, as well as the business proposal system of the Business Results program.

Preferably, personnel are provided with basic awareness of business reports and what they mean can help them better understand and contribute to the financial health of the organization and thus to provide better customer service and products. The secondary benefit is the knowledge that can be applied to the personal lives of personnel, beyond the organization.

Topics included preferably include a basic description of the following: balance sheets, cash flow issues, income statements, stock price valuation, equity and ownership.

A successful Business Results program is maintained by ensuring one has a plan to monitor and evaluate the progress and make a commitment to continuous improvement, such as in step 110 shown in FIG. 2. The Business Results program provides tools for engaging all personnel in providing high quality products and services while also achieving business results.

In an alternative non-limiting example, program 14 for system 10 is a “Values Blueprint program”. The Values Blueprint program is a program for building a successful organizational culture by creating by a shared set of strategic, behavior-based values. Organizations that are successful over time are those whose cultures are built on these values. Values, as an environmental condition, support every other piece of the organizational culture. The role of organizational leaders is to create and maintain a healthy, thriving culture where leaders are free to lead, personnels are given autonomy, mistakes are celebrated, and learning is paramount.

By creating values, guideposts are created for the organization to work from, and once behaviors are written for them, personnel are given the specific actions that preferably exhibit around each value.

Behavior-based values are the basis for the Values Blueprint program, which is based on six principles:

1. Culture can not be forced and only environment can be created. The culture of an organization is the outcome of the environment. By creating the appropriate environment for an organization, the byproduct will be the culture. Culture cannot be created on its own, as it is a lagging indicator of the environment. To try to change the culture is to try to change the result, after the fact.

2. An organization is on the outside what it is on the inside. Those organizations who do customer service best are also those who, not surprisingly, treat their personnel best. The service provided to an organization's customers will never be greater than the service one provides to the organization's personnel.

3. Success is defined as getting the right things done right. One of the most important reasons for identifying and defining an organization's values and behaviors is to help the organization make better decisions. First, the organization needs to identify what are the “right” things. When identifying what the right things are for the organization, consider the following:

The right things should be strategic and align with the goals and objectives of the organization. Organizations often struggle and eventually fail because they have not identified what the right things are, so they try to be all things, unsuccessfully. Once identified, the right things need to be clearly communicated to the entire organization. When the right things are communicated, personnel preferably need to know what those right things look like in action organizationally by providing the personnel the tools and the skills appropriate to accomplish those tasks. In addition, getting the right things done right means that the organization identifies what the right things are and how the organization accomplishes them. Those rules must apply to all within the organization, regardless of their title or their contribution to the organization.

4. People do exactly what they are incented to do, The processes the organization creates for personnel, in large part, determine the success of the organization itself and of its personnel. It is unrealistic and illogical for the organization to believe personnel will act out of alignment with what we are paying them to do. Values are preferably integrated into the organization's processes and an organization needs to constantly evaluate the organization's processes to ensure the organization is paying people to do what the organization are asking them to do. In addition, some personnel are tremendously difficult to deal with, but produce such good numbers that the personnel are untouchable. If the organization allows one person to knowingly operate outside the values, regardless of that person's tenure, performance, or position in the organization, the organization has effectively nullified its values. The message the organization send is that values are important, unless the results are really good. Hire for values; fire for values.

5. Input equals output. Culture maintenance is as big an issue as culture creation. It takes a consistent and constant dedication of resources to maintain a successful culture. The more the organization puts into the culture, the more the organization will get out of it. Again, building a strong culture takes a rigorous dedication of time, commitment and resources. The rigor behind the effort makes the task difficult rather than easy, but the results are certainly worth the effort.

6. Environment must be built on a set of shared, strategic values and financial responsibility. Because environment is the precursor to culture, it can also correctly be assumed that every organization has an environment, too. The environment created is what shapes the culture. If the organization does a good job identifying the environment and working on those environmental issues within the organization, the culture will be a natural by-product of the environment we create.

If the organization creates and builds an environment on a set of values, the decisions made as an organization will reflect the values the organization has identified. If the organization creates a shared set of values, that suggests that the values identified are those which all personnel within the organization (and even its customers) can support. If the organization creates a shared set of strategic values, we know that the values are not self-serving or abstruse, but will truly help build and grow the organization toward meeting its strategic goals.

Preferably, a committee of personnel oversees the administration of the Values Blueprint program within the organization. The committee is preferably representative of various functions and levels throughout the organization. Alternatively, the personnel on the committee includes customers and clients. The committee assists in the application and implementation of the Values Blueprint program throughout all levels of the organization. Preferably, senior management of the organization sponsors and supports the effort of the Values Blueprint program.

The Values Blueprint program preferably obtains input 16 by assessing the values of the organization, such as by survey 18 or the like to determine if the organization's values are appropriate to support a values-based, behavior-driven culture. Survey 18 may be a work product result of the committee overseeing the administration of the Values Blueprint program.

Assessment methods include, but are not limited to, identifying what organizational values are currently in place, determining if those values truly drive the behaviors organizationally instructional, determining if the current values are understood by all personnel. Assessment methods may also include, if the organization has already identified its values but is unsure whether or not they are the right values, the committee overseeing the administration of the Values Blueprint program preferably answers the following questions and discusses the responses.
Does the organization have a set of identified core values?
Do those core values drive the decisions made by the organization at all levels?
Can every ePersonnel within the organization state the values by memory?
Has the organization assigned specific behaviors to the values?
Are the values integrated into the hiring process? (Do the interview questions reflect the values the organization is looking for in its candidates?)
Are the values integrated into the review process? (Does the organization hold its ePersonnels accountable for living the values by making them a part of their performance evaluation?)
Does the organization hire for values? (Is the organization willing to hire someone who may not have all of the trainable skills necessary but does exhibit all of the values?)
Does the organization fire for vlues? (Is the organization willing to hire a high performing ePersonnel who does not live by the values created?)
Does the organization provide rewards and recognition to personnels based on values?

Whether revising, recommitting, or creating new values, the committee overseeing the Values Blueprint program preferably undergoes the Values Blueprint program exercise, which preferably serves as the decision document for all personnel, as each of the personnel work together to build a more successful organization. This blueprint preferably make the values an integral part of the organizational structure by identifying the behaviors which accompany each value. The behaviors help personnel understand how to embody those values. The behaviors then become the identified behaviors which drive the sub-programs, such as hiring, rewarding, and recognizing performance, discussed in more detail below.

The committee integrates and refines all values captured from the survey or group discussion 18 into core corporate values as inputs 16. Inputs 16 of the Values Blueprint program, therefore, are value inputs and are entered into the program 14. The committee subsequently develops behavioral statements to support each value as inputs 16 into the program. Program 14 then generates at least one values-based, behavior-driven factor 20 based on input 16. Preferably, factor 20 is a value factor. Alternatively, factor 20 is a behavior factor, or factor 20 may be both a value factor and a behavior factor.

Values are those fundamental and foundational tenets or ideals that drive behavior either individually or organizationally. Organizational values determined in survey 18 may be understood by first putting them into context with a description of personal values. If individuals will think about their own, individual/personal values, this is a good way for them to begin to think about organizational values, as they are typically very similar. Personal values are those beliefs held so strongly that it drives one's behavior in how one deals with and treats others. Values that drive individual behavior are similar to those that drive corporate behavior. It is important, however, to include in the values some form of business objective.

Exercise 1—identify core Organizational values

As discussed in the earlier section, a true core values will be known if it is a core value when an organization can hire to it, promote to it, evaluate to it, reward to it, and fire to it.

The following values are good (non-limiting) examples of true core organizational values:

1. Integrity

2. Respect

3. Devotion

4. Courage

5. Fun

6. Trust

7. Flexible

8. Positive Attitude

9. Efficient

10. Teamwork

11. Dependable

12. Safety

By identifying the specific behaviors the organization wants to see in order to support that value, the organization helps personnel better understand the values, and gives life to the values by defining what they look like within the organization. Here are some (non-limiting) examples of behaviors that support the values:
Integrity
We are honest with ourselves and our clients. We let the numbers and referrals reflect our success.
We do the right thing, even when no one is looking.
We are impeccable with our word.
We live and demonstrate our values.
Respect
We always treat people the way we want to be treated.
We listen.
We encourage everyone.
We promote individuality.
We promise to keep an open mind.
We engage in other's perspectives.
Demonstrates to others that their opinions are important.
Actively listens to others.
Is willing to confront others when something is out of alignment with the values or organizational direction.
Devotion
We are active and willing participants in the success of ourselves, each other, and our clients.
We are dedicated to always doing our best.
We consistently strive to give our clients more than they ask for.
Courage
We have the courage to move out of our comfort zone.
We are not afraid to ask for help.
We have courage to express ourselves freely.
We have courage to believe in ourselves.
Fun
We promote creative thinking and collaboration.
We enjoy what we do.
We are able to laugh . . . and do often.
We celebrate success.
Trust
We value each person's contribution and support growth.
We are reliable and knowledgeable to fulfill the best interest of each other and our clients.
We are willing to trust and are trustworthy.
Flexible
Demonstrates an ability to change courses without frustration or consequence.
Is willing to listen to and entertain new ideas.
Is able to act without all information.
Positive Attitude
Consistently demonstrates an ability to overcome obstacles with positive energy and enthusiasm.
Is able to use humor to diffuse a negative situation.
Is willing to go the extra mile for the customer, internal or external.
Consistently does more than is asked, with energy and enthusiasm.
Efficient
Establishes courses of action for self and others to ensure work is accomplished efficiently. Prioritizes tasks appropriately.
Adjusts priorities when appropriate.
Uses resources wisely and appropriately.
Allocates appropriate amount of time for completing own work.
Teamwork
Communicates well with other people on the team.
Seeks collaborative solutions to problems.
Is willing to confront with respect, when appropriate.
Supports team members in their actions, when appropriate.
Dependable
Consistently follows through on all commitments.
Follows up with others on responsibilities and actions.
Returns calls and other correspondence in a timely manner.
Has a successful attendance record.
Honesty
Is willing to have difficult conversations with others, when necessary.
Is willing to admit mistakes and takes accountability for actions.
Acts in accordance with the our values.
Demonstrates a value for honesty over organizational politics.

Preferably the Values Blueprint program is communicated to personnel throughout the organization such as by using values during regularly scheduled meetings, by highlighting values “stars”—when someone in the organization is demonstrating the values, make sure that person is recognized in a significant way, by making the values and behaviors visible—make sure that where meetings take place, the values and behaviors are visible, by making the values and behaviors part of formal communication, such as an intranet, a newsletter, a message from the president—any formal means of communication—to discuss the values and behaviors in action and by mention how the values have been seen in action and the positive results that have been associated with them. In addition, the Values Blueprint program preferably include methods for discussing values and receiving feedback from personnel.

A key to implementing a values-based, behavior-driven culture is to ensure that values and behaviors are included in each of sub-programs 22, discussed in more detail below including, but not limited to, recruiting, hiring, training, review, compensation, recognition, and rewards programs.

Creating a values map involves the review of each of the organization's sub-programs 22 by the committee overseeing the Values Blueprint program. The values map template will guide the committee overseeing the Values Blueprint program in creating a values map for the organization.

A successful Values Blueprint program is maintained by ensuring the organization has a plan to monitor and evaluate its progress and make a commitment to continuous improvement, discussed in more detail below.

In a non-limiting example, sub-program 22 for system 10 is a “Selection and Hiring program”. The Selection and Hiring program is a behavioral interview approach to assist the organization in selecting the best-qualified people through behavioral interviewing. Behavioral interviewing is asking open-ended questions about specific past experiences, which gives the interviewer a good idea of how the candidate reacted in a particular situation and how the candidate will most likely react in the same or similar situation in the future. An example of a behavioral question is: “Tell me the last time you had to deal with an angry customer and how did you handle him/her?”

The Selection and Hiring program preferably includes three common elements, hiring right, fairness and consistency, and team confirmation.

Hiring right is the ability to select the right people by utilizing the values of the organization and determining the behaviors desired for each position based on a competency profile. This methodology is used to validate and predict a candidate's job performance.

Fairness and consistency means interviewing every candidate in the same manner. This ensures consistency from interview to interview. When using this process, it is difficult to ask illegal questions. The candidate feels and tells others that the process is fair, and he/she had a fair chance at the job. This is so important because if the candidate does not come to work for the organization, the organization wants the candidate to think highly enough of the company that they become and remain a customer.

Team confirmation is a reality when feedback is received from all levels of the organization that the process is working. This is crucial for any interview selection system to be successful. The peers that assist in the interview process must believe in it to participate. The peers must feel that it is time well spent away from their regular job duties. Compromising the values is not an option, which shows tremendous dedication and ownership to the process. Operations managers must believe in the process in order to feel comfortable letting go of the reigns. Fellow peers need to believe that the process is credible because they work with these new people every day. In addition, those that are hired should feel, immediately, that they fit in.

By utilizing hiring right, fairness and consistency, and team confirmation, the Selection and Hiring program overcomes many difficulties associated with traditional selection models. Preferably the Selection and Hiring program utilizes a planned recruiting strategy.

Preferably, a committee of personnel oversees the administration of the Selection and Hiring program within the organization. The committee or team is preferably representative of various functions and levels throughout the organization. Alternatively, the personnel on the committee includes customers and clients. The committee assists in the application and implementation of the Selection and Hiring program throughout all levels of the organization. Preferably, senior management of the organization sponsors and supports the effort of the Selection and Hiring program.

Preferably, the Selection and Hiring program includes an assessment of the organization's current hiring practices, which helps the organization determine its need for improving its hiring practices. The art of hiring is ongoing and iterative. With every new hire, the organization changes slightly. Improvements must be made to continue to grow the organization and the culture.

Once the hiring practice assessment is completed and opportunities have been identified to improve the organization's hiring practices, the next step is to develop a plan for designing values-based hiring practices.

At least one value factor 20 from the Values Blueprint program is utilized by the Selection and Hiring sub-program 22 to generate an output 24. Preferably, output 24 is a values map, discussed in more detail below. Selection and Hiring sub-program 22 is utilized to determine which values factor 20 generated by program 14 is to be utilized in values map output 24.

The first step in creating a values-based hiring plan is to review the organizational values blueprint from the Values Blueprint program and determine where the values and behaviors identified fit into the hiring practices. The values identified should be important enough to create a hiring strategy based on those values. The goal of the organization is to hire people who fit the organization's culture, and that will not happen by chance. By focusing on making the organization's values an integral part of the organization's hiring process, it will ensure that the organization hires personnels that fit its culture.

The following worksheet may be used to develop a Selection and Hiring values map for the organization. This values map will provide a blueprint for the organization's Selection and Hiring design plan. Use the values map to determine how the organizational interviewing and hiring practices are aligned with the organization's values and look for opportunities to better align the interviewing and hiring practices with the organization's core values.

Alternatively or in addition to the values map, output 24 is a Design Plan that utilizes at least one value factor 20 from the Values Blueprint program. At this stage in the process, the Selection and Hiring committee should begin to identify the ideal Selection and Hiring Design for the organization. The Selection and Hiring values map will be used to identify the opportunities to better align the organization's selection and hiring practices with the organization's values. This analysis along with more understanding about the values-based approach to performance management, will give the team ideas about how to change the current selection and hiring practices. With the Selection and Hiring team, use the following Selection and Hiring Design Plan worksheet to develop a new blueprint for a customized Selection and Hiring program.

Alternatively, output 24 is a key attribute profile that includes key attributes about certain job positions within the organization. Preferably, key attributes are related to values factors 20, behavior factors 20, or a combination of values factors and behaviors factors 20 determined in the Values Blueprint program. Preferably, the factors 20 are integrated into the key attributes profile. The goal of integration is to breathe life into the values and behaviors by taking the words off of the page and incorporating them into the way that the organization recruits, interviews, trains, rewards, recognizes, promotes, and possibly separates personnel.

Alternatively, output 24 is a Selection and Hiring selection or interview guide, which includes specific behavioral interview questions designed to help evaluate how the candidate fits the key attributes identified for a specific job. The behavioral questions are related to the values factors and behaviors factors determined in the Values Blueprint program and preferably ensures that the organization hires the right candidate because the organization receives a full picture of the candidate's past behaviors and is able to determine if the candidate matches the job key attributes and organizational values, ensures fairness and consistency because the organization interviews everyone in the same manner, prevents an interviewer from asking illegal questions because the interview guide creates a structured process for the interview, avoids many common selection mistakes because the focus is on how the candidate has behaved in past jobs vs. “first impressions”, and creates confidence that candidates are evaluated on their abilities to do the job and whether they will like doing the job within the organization.

Preferably the Selection and Hiring selection guide follows a standard format. Preferably, up to three selection guides are created for each position. The selection guides for each position are unique based on the questions plan to be asked for each key attribute. The format for the Selection and Hiring program selection guide is preferably includes cover page, background confirmation, story time, company match, saying goodbye, and interviewer rating worksheet.

Preferably, the multiple versions of the interview guide of the Selection and Hiring program selection guide is utilized by a team interview and have different questions for each competency to ensure that all key attributes get covered adequately by various members of the interview team. This also ensures that the applicant is not asked the same questions by all interviewers.

Alternatively, output 24 is a selection guide matrix or a team selection decision worksheet that utilizes at least one value factor 20 from the Values Blueprint program.

The following steps help guide the Selection and Hiring team in planning and coordinating interview teams for each position:

Step 1: Prioritize the key attributes for each position into two categories: critical attributes and contributing attributes.

Step 2: Complete an interview team matrix to plan adequate coverage of the interview questions, assigned by selection guide, for each of the key attributes.

Immediately after completing the interview and the candidate leaves, the evaluation and grading process of the interview begins, including at least the following steps:

Step 1: Organize notes.

Step 2: Review “Observations” line.

Step 3: Identify complete stories.

Step 4: Determine the importance of each complete story.

Step 5: Grade the competency.

The final stage of the interview is when all members of the interview team convene to discuss the information gathered during the interview and the individual grades they assigned to each competency. Consensus takes place as soon as possible after the interview so the information is fresh in the team's mind. At this stage, the interview team makes the decision to recommend or not recommend the candidate for the next phase of the process.

This process is instrumental in ensuring that hiring decisions are fair, consistent, and credible. It is also imperative that each member of the interview team share and discuss the information received and their reasons for grading the key attributes as he/she did. Each member has an equal say during this phase, which encourages buy-in among all involved. This share and discuss session also motivates each member to hold the other accountable for the hiring standards of the company.

Once the interview has been completed, the selection decision has been made and the offer accepted, the new personnel will be assigned a date to report to work. Typically, the new personnel attends a new employee or personnel orientation. Ensure the organization takes time to introduce the organization's new personnel to the values and behaviors during this first, critical introduction to the organization. This is an opportunity for to provide examples of how the values and behaviors are at work in the organization. Use real life examples to make the values real for new personnel. This is also a good time to set expectations for new personnel regarding the values and behaviors. This is the best time to capture the new, fresh minds of the organization's personnel, so make sure to give them examples they can use to help drive their behavior.

Preferably, the Selection and Hiring program is communicated to personnel to keep them apprised of the way in which the organization plans to hire personnel, such as in step 108 shown in FIG. 2. Although the only personnel who will go through the Selection and Hiring program process should be those who have direct hiring responsibilities, all personnel should be aware of the process.

Preferably the Selection and Hiring program is communicated to personnel by introducing the Selection and Hiring program as a part of formal communication—If the organization has an intranet, a newsletter, a message from the president—any formal means of communication. In these communications, discuss why the Selection and Hiring program was designed for the organization, how it is values-based, and the benefits hoped to gain by the new program, by discussing the new Selection and Hiring program during regularly scheduled meetings and emphasizing the new role for the personnel in the Selection and Hiring program process and how it will be different from the organization's current interviewing and selection process. In addition, a method should be established to answer frequently asked questions (FAQs), such as by an intranet website or other regular organization personnel communication tools, training should be provided to personnel about their new role in the Selection and Hiring program process including how to conduct behavior-based interviews and how to interview as a part of a team, and include personnel feedback as a part of the Selection and Hiring program communication strategy. Personnel feedback is important in both the initial introduction of the new program as well as in the continuous improvement process.

A successful Selection and Hiring program is maintained by ensuring there is a plan to monitor and evaluate the organization's progress and make a commitment to continuous improvement as in step 110 shown in FIG. 2.

In an alternative non-limiting example, a sub-program 22 for system 10 is a “Total Rewards program”. The Total Rewards program includes base and variable pay plans, recognition programs, and creative core and non-traditional benefits. The core values and guiding principles of an organization are driven by top management. A leader who values family will be more supportive of family friendly benefits. A leader who values learning and education will be more supportive of tuition assistance and sabbatical programs. Understanding these values and designing total rewards program components that support the values can lead to greater success.

Preferably, a committee of personnel oversees the administration of the Total Rewards program within the organization. The Total Rewards program committee or team is preferably representative of various functions and levels throughout the organization. Alternatively, the personnel on the committee includes customers and clients. The committee assists in the application and implementation of the Total Rewards program throughout all levels of the organization. Preferably, senior management of the organization sponsors and supports the effort of the Total Rewards program.

Preferably, the first step in the process should begin with a review of the organization's internal processes around total rewards. Once the total rewards assessment is completed and identified opportunities to improve the organization's total rewards strategy, the next step is to develop a plan for designing values-based total rewards strategy.

The first step in creating a values-based total rewards strategy is to review the organization values blueprint created in the Values Blueprint program and determine where the values and behaviors identified in the values blueprint from the Values Blueprint program fit into the total reward plan. Review the values and behaviors from the organization's values blueprint and map these to the organization's current total rewards program. Determine where the organization has gaps and which values the organization needs to reinforce with rewards to gain an advantage. By focusing on making the organization's corporate values an integral part of the organization's total reward strategy, this ensure that the organization rewards personnel for the right behaviors.

For example, if the organization values say innovation is important to the business, are there programs in place that encourage risk taking and does the organization recognize and reward those achievements by personnel or groups of personnel? Or, are personnel punished for taking risks and accountable for every mistake?

If family and a nurturing culture is an important part of the organization value system, does the organization benefits programs reflect that? For example, are flexible work arrangements encouraged, does the organization contribute to the cost of family health coverage, and does the organization have a catastrophic fund to assist personnel with significant unplanned financial obligations?

The following worksheet may be used to develop a Total Rewards program values map for the organization. This values map will provide a blueprint for the organization's design plan. Use the values map to determine how the organization's Total Rewards strategy is aligned with the organization's values and look for opportunities to better align the organization's Total Rewards strategy with the organization's core values.

Preferably, the Total Rewards program includes building a total rewards graphic to better illustrate exactly how the organization is spending its people dollars and to allow for a discussion around desired changes. With the organization's Total Rewards program Team, look at the total view of the organization's rewards expense and identify opportunities where the organization may want to make changes in the allocation to better align the organization rewards program with the organization's goals and values.

Evaluate the organization's current people expense against external metrics (benefit cost as a percent of payroll, as a percent of sales, etc.) and against the organization's values. The average benefit cost as a percent of total payroll for most organizations is 35-40%. However, this percent can vary based on the industry, the size of the organization, the geographic location, and the demographics of the workforce. Also, the organization's culture and values around the employment relationship will influence the level of benefits costs.

With the Total Rewards program team, discuss the total view of the organization's current total rewards program and determine the total view of desired expense allocation in the future and develop a total rewards strategy for the organization based on the organization's key business strategies and the following six factors:

Industry

Size of Organization

Demographics of Workforce

Financial status/maturity of organization

Geographic Location

Organization's core values

For example, if the organization has a strategy to hire more experienced nursing staff, the retirement plan may need to be enhanced by adding a higher match, etc. Therefore, cost of the 401 (k) plan would increase and this may require reducing, or controlling, costs in another area. Often an opportunity exists to change the mix between major benefit categories. These decisions should be driven by the business, the need for retaining current talent, and the competitive market around attracting new talent.

Preferably, the Total Rewards program includes an Internal Assessment including an assessment of pay programs including each component of pay, an inventory and assessment of the organization's current benefit programs, including personnel listening for benefits.

Preferably, the Total Rewards program includes an External Rewards Assessment of the organization's pay and benefit program, which is compiled for each benchmark job in the organization, as well as for personnel benefits and a review of the organizational values blueprint to assess the organization's current rewards programs to determine if/how they support the organization's values.

The Total Rewards program provides an advantage when organizations design variable pay plans that engage personnel, truly reward individual and team performance, and link rewards to the business.

Although the prevalence of variable pay varies by industry, most industries use some form of variable pay through the following vehicles, profit sharing, gain sharing, group incentives, spot bonus awards, sales incentives, and equity plans.

Preferably, the Total Rewards program provides guidelines for managers and gives managers the training and tools to effectively reward the organization's personnel. Not every situation can be addressed with a set rule. The size and type of reward must fit the situation, and the manager is the best one to evaluate and make that decision.

Base pay forms the foundation and gaps should be addressed but variable pay creates the competitive advantage. Variable pay has six components

1—Eligibility

The organization's design team will need to determine eligibility guidelines for the program. The criteria may be based on level/title within its organization, on a minimum base salary cutoff, or on the specific role the individual plays in the organization.

2—Type of Plan

The type of plan desired should be defined early in the process. Some organizations want all or a portion of the award to be discretionary. Most high performing organizations set and communicate goals and targets for performance that must be achieved for a pay out to occur.

3—Performance Measures

The actual performance measures used for the plan should be directly linked to the organization's dashboard metrics, such as those determined in the Business Results program. These may be purely financial measures (revenue, net income, ROI) or they may be non-financial measures that focus on quality, customer satisfaction, product development, etc. Many organizations find a combination of financial and non-financial measures to be the best solution.

4—Size of Award

A common approach to setting the size of the award is to present this as a percent of base pay. These awards typically range from 5% of pay for front line personnel to as much as 50% of pay for Senior Level Management.

5—Frequency/Timing of Award

Award payouts must be directly linked to the measures being used for the incentive plan. If performance can be accurately measured against a target for front line personnel on a monthly basis, then payouts should be that frequent. Some measures, such as Net Income, require an annual payout. Care should be taken in designing plans to ensure the award amounts are large enough to be effective, administratively efficient, but frequent enough to keep personnel engaged.

6—Form of Payment

Depending on the basic objectives of the plan, the number of participants and the overall design of the plan, the team must decide if awards will be paid out in cash, packaged as deferred compensation or a combination of these. The most common incentive payout method is cash. However, profit sharing and equity plans often have a deferred element.

The concept of line of sight. This is one of the most critical elements of variable pay design. In order for an individual to be engaged in the business, to change behavior, and to expend energy to achieve a specific goal, he/she must have a clear line of sight. Participants must perceive that they can influence the results. The following chart describes the concept of line of sight related to several personnel perspectives and suggests that a balance must be achieved. For example, senior management deals regularly with broad financial measures such as net income results, clearly understands what influences these results, and makes decisions every day to achieve the best results. However, personnel on the front line typically don't deal with this measure on a regular basis and are often focused on more operational results (quality, quantity produced, customer satisfaction, etc). The Total Rewards program provides the tools for organizations to educate all personnel on the key business metrics, such as those determined in the Business Results program and to help them understand how their day to day behavior can influence business results.

Preferably, the Total Rewards program provides a competitive advantage of benefits plans by creating a new set of benefits sometimes called non-traditional or facilitative benefits. The idea is to better meet the needs of the changing workforce and to help personnel handle the challenges of dual income, single parent, and extended family units.

The organization's values blueprint from the Values Blueprint program provides much of the information needed to develop an approach to non-traditional benefits. These benefits offerings are often driven by the culture of the organization which reflects the beliefs and value system of the organization's senior management.

Traditional benefits form the foundation and gaps should be addressed but non-traditional benefits create the competitive advantage. Non-traditional Benefits, sometimes referred to as facilitative benefits, are offered by a smaller group of organizations and sometimes are more prevalent in certain industries. These programs offer a great upside opportunity to create competitive advantage for the organization. This summary shows the most common programs offered, but there are many other opportunities to implement new programs that are often much less expensive and as valued as the traditional health and welfare plans.

The following chart lists a variety of non-traditional benefits and, for purposes of discussion, groups them into three categories:

1) Work/Life balance

2) Recognition

3) Learning and development

Many of these programs are very simple to implement and have limited costs associated with them. Others may require enhanced communication and education to make them of value to personnel.

A business plan, an implementation plan, and cost projections for the Total Rewards program should be provided, including return-on-investment (ROI) analysis, revenue enhancement factors, and cost avoidance factors.

The Total Rewards program is preferably communicated to personnel by using a pilot roll out, developing Q&A, gaining manager and supervisor support early, and by focusing on total rewards, such as in step 108 shown in FIG. 2.

At least one value factor 20 from the Values Blueprint program is utilized by the Total Rewards program sub-program 22 to generate an output 24. Preferably, output 24 is a Total Rewards or benefits Statement, discussed in more detail below. The Total Rewards sub-program 22 is utilized to determine which values factor 20 generated by program 14 is to be utilized in benefits statement output 24.

Preferably, the Total Rewards Statement includes all elements of the individual pay and benefits programs and helps personnel understand the true cost of benefits, reinforces the different components of the Total Rewards package, can be personalized for each personnel, and encourages personnel to regularly review benefits elections and personal information for accuracy. A complete Total Rewards Statement should include all components—everything perceived to be of value by personnel. In addition, be sure to include all costs to the organization, specifically statutory benefits costs such as Unemployment Insurance, Worker's Comp, FICA.

A successful Total Rewards program is maintained by ensuring the organization has a plan to monitor and evaluate the organization's progress and make a commitment to continuous improvement, such as in step 110 shown in FIG. 2.

In an alternative non-limiting example, sub-program 22 for system 10 is a “Performance Management program”. The Performance Management program is a values-based performance management process that aligns individual performance expectations with dashboard metrics and behavior-based values. As discussed previously in the Business Results program, the driver of organizational performance is the organizational dashboard. Based on the metrics of the organizational dashboard of the Business Results program, work teams establish metrics for work team dashboards. Reward-centered games are then established to reward team members for the team and organizational performance.

The Performance Management program is the process of linking accountability for individual performance to the organizational and work team dashboards. It is important for managers and supervisors to establish and communicate performance expectations for all personnel that are based on the work team dashboard. In this way, all personnel understand what it takes to achieve the work team dashboard results. And, all personnel understand how their performance contributes to the team results.

Individual performance expectations are the basis for the performance appraisal. The Performance Management program is based on the philosophy of values-based performance management. The philosophy of values-based performance contains three key elements:

Individual personnel are responsible for meeting the metrics and demonstrating the behaviors that define the organization's values, from the Values Blueprint program. Individuals are accountable to their team for contributing to achieving the work team metrics. And, individuals are accountable to individual team members for their behavior in demonstrating the organizational values.

Individual personnel need to meet individual performance expectations that are defined by the dashboard metrics for the work team. Individual metrics are established as either performance standards or performance objectives that contribute to the work team dashboard.

In addition to the metric-based performance criteria, individuals are held accountable for demonstrating behaviors that support the organizational values. Behaviors are defined for specific positions or work teams. These behaviors are evaluated as a part of the performance appraisal process and given a high level of importance in the overall performance rating. Individuals are expected to demonstrate the organizational values at all times in all interactions with personnel and customers. In a values-based culture, it is important to hold personnel accountable for demonstrating the defined behaviors of the organizational values, from the Values Blueprint program.

Because individuals are accountable to their team for achieving the team metrics and for demonstrating values-based behaviors, the most important input to the performance appraisal process comes from fellow team members at all levels. The Performance Management program performance appraisal process is designed to include peer feedback.

Preferably, a committee of personnel oversees the administration of the Performance Management program within the organization. The committee is preferably representative of various functions and levels throughout the organization. Alternatively, the personnel on the committee includes customers and clients. The committee assists in the application and implementation of the Performance Management program throughout all levels of the organization. Preferably, senior management of the organization sponsors and supports the effort of the Performance Management program.

Preferably, the Performance Management program assesses whether or not the current performance management practice is value-based. Values-based performance management practices are personnel-centric. In this approach, each personnel has more sources of information to know what is expected, how they are doing and how their performance is ultimately evaluated. In the values-based performance management model, an individual personnel's performance is evaluated based on meeting the metrics, living up to the organizational corporate values from the Values Blueprint program, and on team feedback. The values-based model assumes that the personnel has a responsibility to understand what is expected, to meet the expected performance criteria, live up to the organizational values, and meet expectations of team members.

At least one value factor 20 from the Values Blueprint program or at least one metric factor 20 from the Business Results program is utilized by the Performance Management program sub-program 22 to generate an output 24. Preferably, output 24 is a values map or a design plan, discussed in more detail below. The Performance Management sub-program 22 is utilized to determine which values factor 20 generated by program 14 is to be utilized in values map output 24 or design plan output 24.

In values-based performance management practices, the role of the manager shifts from that of being the primary source of performance information to serving as a facilitator of performance management.

The following worksheet may be used to develop a Performance Management program values map for the organization. This values map will provide a blueprint for the organization's design plan. Use the values map to determine how the organizational performance management practices are aligned with the organization's values and look for opportunities to better align the organization's performance management practices with the organization's core values.

At this stage in the process, the Performance Management program team should begin to identify the ideal Performance Management program design for the organization. The values map will be used to identify the opportunities to better align the organization's Performance Management program practices with the organization's values. This analysis along with more understanding about the values-based approach to performance management, will give the team ideas about how to change the organization's current performance management practices. With the Performance Management program team, use the following Performance Management program Design Plan worksheet to develop a new blueprint for a customized Performance Management program.

Typically, the Performance Management program is implemented by identifying one or more key positions to focus on initially. Generally, the focus is on positions which will provide the greatest value most immediately by an improved performance management process. This decision is based the realities of the current performance management environment. Here are some criteria for making a decision about which positions to take first through the Performance Management program process:
Positions that have a high turnover history which may be improved by a more effective performance management process.
Positions that represent high value to the organization through the investment of training and intellectual capital.
Positions that represent a potential high cost to the organization if performance is not managed well.
Positions where the organization has experienced performance issues in the past.

The Performance Management program team may also consider starting with the positions that are being targeted for initial implementation by the Selection and Hiring team, discussed above.

The Performance Management program team is responsible for implementing the Performance Management program in the organization including, corporate and work team dashboards, corporate values, individual performance expectations, continuous feedback, recognition and rewards, coaching for performance improvement, disciplinary action, quarterly bonus or incentive payouts, performance appraisal, and performance management decisions

Based on the results of the performance and appraisal process, performance management decisions may be made with individuals, including salary recommendations, bonuses, incentives, career planning, promotions, and developmental planning. Skills for making and communicating these performance management decisions are presented in management training courses.

The key to a high performance culture is values-based performance expectations. It is important for all personnel to understand exactly what is expected of them, both in terms of achieving performance results and in terms of demonstrating behavior that fits the corporate values and culture. Clear performance expectations help personnel understand what their role is in achieving the overall results for the corporation and their team. Individual performance expectations are the basis for performance coaching and for the performance evaluation.

Once individual performance expectations are established, everyone understands what it takes to move the metrics on the dashboard. All personnel understand what is expected to contribute high quality products and services to the customer.

At least one value factor 20 from the Values Blueprint program or at least one metric factor 20 from the Business Results program is utilized by the Performance Management program sub-program 22 to generate an output 24. Preferably, output 24 is a performance dashboard, discussed in more detail below. The Performance Management sub-program 22 is utilized to determine which values factor 20 generated by program 14 is to be utilized in performance dashboard output 24.

Example of a Performance Dashboard

Most often performance expectations are expressed in the form of measurable performance standards or performance objectives that relate to the dashboard metrics. A key component of the Performance Management program is values-based performance expectations. These are expected behaviors that support the values, from the Values Blueprint program.

Performance standards are a type of performance expectation that has been set for a long period of time and seldom changes. Performance standards may apply to a group of personnel that perform the same job functions or may be established by industry norms or historical data. Examples of performance standards include: answering by the phone by the third ring, returning calls the same they are received, units sold per day, items processed per day, compliance with all safety requirements, and the like.

Performance objectives are a type of performance expectation that is more specific to an individual, usually established mutually by the manager and reporting personnel. Performance objectives are targeted for a specific period of time and are changed as needed to meet overall corporate and work team goals. Examples of performance objectives include, complete a financial cost analysis within two months, implement a safety training program for all personnel in six months, generate $2 million in sales in one year, and maintain 95% customer satisfaction rating.

A key component of a values-based performance management system is holding personnel accountable for living up to the corporate values. Personnel are expected to demonstrate the behaviors defined by the organization's corporate values blueprint from the Values Blueprint program at all times with customers and the organization's personnel. For this reason, peers and even customers provide input about all personnel's ability to live up to the values, using a “multi-rater” process, for the annual performance evaluation. The results from these raters are compiled and included in all personnel's performance appraisal as an important factor in the overall evaluation. Examples of living up to the values include maintains respectful relationship with organizational personnel and customers, is committed to self-improvement, exhibits a sense of humor and is able to laugh at self, and champions team spirit.

Performance standards and objectives need to be well written in order to use them effectively in performance evaluation and coaching personnel for performance improvement. Well written performance standards and objectives meet the following criteria: measurable, (quality, quantity, and timeliness) achievable, relevant, controllable.

At least one value factor 20 from the Values Blueprint program or at least one metric factor 20 from the Business Results program is utilized by the Performance Management program sub-program 22 to generate an output 24. Preferably, output 24 is an evaluation guide, discussed in more detail below. The Performance Management sub-program 22 is utilized to determine which values factor 20 generated by program 14 is to be utilized in evaluation guide output 24.

The Performance Management program team will develop a performance planning and evaluation guide to help managers develop values-based performance expectations and evaluate performance based on values. The team will need to review the organization's current performance evaluation form and determine how to modify it to support a values-based performance planning and evaluation process.

Preferably, the Performance Management program is communicated to personnel, such as in step 108 shown in FIG. 2, by introducing the Performance Management program as a part of formal communication n intranet, a newsletter, a message from the president, discussing why the Performance Management program was designed for the organization, how it is values-based, and the benefits hoped to be gained by the new program. Managers and team leaders should discuss the new Performance Management program during regularly scheduled meetings—during meetings, remember to emphasize the new role for the organization's personnel in the Performance Management program process and how it will be different from the organization's current performance management process. Preferably, a method is established to frequently asked questions (FAQs). This may be via an intranet website or other regular personnel communication tools. In addition, the Performance Management program should plan to include personnel feedback as a part of the Performance Management program communication strategy. Personnel feedback is important in both the initial introduction of the new program as well as in the continuous improvement process.

A successful Performance Management program is maintained by ensuring it has a plan to monitor and evaluate the organization's progress and make a commitment to continuous improvement, such as in step 110 shown in FIG. 2. Continuous improvement is the result of a following the discipline of a structured process for improvement. The continuous improvement of the Performance Management program process is based on an annual review of the program by the Performance Management program team.

It is the responsibility of the Performance Management program team to make sure the organization evaluates the success of the Performance Management program on an annual basis. The organization will want to understand how the organization's personnel are doing with respect to the Performance Management program.

The Performance Management program team needs to spend some time deciding how it will review the success of the Performance Management program on an annual basis. Communication here is the key. Management needs to keep its collective mind open about changes. Management needs to continually ask personnel and customers for their feedback and be prepared to make the suggested changes, where appropriate.

Additionally, personnel need to be thoughtful about their experiences as personnel and feed their suggestions back to management. Listening to the organization's customers and the organization's personnel will create the most valuable opportunities for improvement for the organization.

The Performance Management program team should develop an annual plan for reviewing the progress of the Performance Management program in the organization.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above and/or in the attachments, and of the corresponding application(s), are hereby incorporated by reference.

What is claimed is:

1. A software system for developing a values-based, behavior-driven human resources system for at least one organization, said organization including a plurality of personnel, comprising:
a software program operable to receive at least one input and generate at least one values-based, behavior-driven business factor based on said at least one input;
a sub-program operable to receive said at least one business factor and generate at least one output based on said at least one business factor and communicate said at least one output to the personnel.

2. The system of claim 1 wherein said at least one input is a one of a culture input, a value input, and a behavior input.

3. The system of claim 1 wherein said at least one values-based, behavior-driven business factor is a one of a value factor, a behavior factor, and a metric factor.

4. The system of claim 1 wherein said at least one output is at least one of an interview guide, a selection guide, an evaluation guide, a values map, a design plan, a benefits statement, a dashboard measurement, a performance dashboard, a game, a reward, a recognition, and an attribute profile.

5. The system of claim 1 including means for monitoring and continuously improving said input, said values-based, behavior-driven business factor, and said output

6. The system of claim 1 wherein said at least one input is a culture input, said at least one values-based, behavior-driven business factor is a metric factor, and said at least one output is a dashboard measurement.

7. The system of claim 1 wherein said at least one input is a value input, said at least one values-based, behavior-driven business factor is a value factor, and said at least one output is an interview guide.

8. The system of claim 1 wherein said at least one input is a value input, said at least one values-based, behavior-driven business factor is a value factor, and said at least one output is a benefits statement.

9. The system of claim 1 wherein said at least one input is a value input, said at least one values-based, behavior-driven business factor is a value factor, and said at least one output is an evaluation guide.

10. The system of claim 1 wherein said at least one input is generated from a team selected from the personnel.

11. A method for developing a values-based, behavior-driven human resources system for at least one organization, said organization including a plurality of personnel, comprising the steps of:
providing a software program on at least one computer, said software program operable to receive at least one input and generate at least one values-based, behavior-driven business factor based on said at least one input;
providing a sub-program, said sub-program operable to receive said at least one business factor and generate at least one output based on said at least one business factor and communicate said at least one output to the personnel.

12. The method of claim 11 wherein said at least one input is a one of a culture input, a value input, and a behavior input.

13. The method of claim 11 wherein said at least one values-based, behavior-driven business factor is a one of a value factor, a behavior factor, and a metric factor.

14. The method of claim 11 wherein said at least one output is at least one of an interview guide, a selection guide, an evaluation guide, a values map, a design plan, a benefits statement, a dashboard measurement, a performance dashboard, a game, a reward, a recognition, and an attribute profile.

15. The method of claim 11 including means for monitoring and continuously improving said input, said values-based, behavior-driven business factor, and said output

16. The method of claim 11 wherein said at least one input is a culture input, said at least one values-based, behavior-driven business factor is a metric factor, and said at least one output is a dashboard measurement.

17. The method of claim 16 wherein said at least one input is a value input, said at least one values-based, behavior-driven business factor is said dashboard measurement program, and said at least one output is an evaluation guide.

18. The method of claim 11 wherein said at least one input is a value input, said at least one values-based, behavior-driven business factor is a value factor, and said at least one output is an interview guide.

19. The method of claim 11 wherein said at least one input is a value input, said at least one values-based, behavior-driven business factor is a value factor, and said at least one output is a benefits statement.

20. The method of claim 11 wherein said at least one input is a value input, said at least one values-based, behavior-driven business factor is a value factor, and said at least one output is an evaluation guide.

21. The method of claim 11 wherein said at least one input is generated from a team selected from the personnel.
